(19) United States
(12) Patent Application Publication
(10) Pub. No.: US 2008/0283537 A1
(43) Pub. Date: Nov. 20, 2008

(54) SPILL-RESISTANT CUPS WITH ACTIVE INGREDIENT DELIVERY SYSTEMS

(75) Inventors: David Smith, Monticello, IL (US); Barbara Smith, Monticello, IL (US); John Funk, Evergreen, CO (US)

Correspondence Address: PERKINS COIE LLP;PATENT-SEA, P.O. BOX 1247, SEATTLE, WA, 98111-1247, US

(73) Assignee: Evergreen Innovation Partners I, LP, Evergreen, CO (US)

(21) Appl. No.: 12/111,170

(22) Filed: Apr. 28, 2008

Related U.S. Application Data
(60) Provisional application No. 60/914,662, filed on Apr. 27, 2007.

(51) Int. Cl. A47G 19/22; B67D 5/06; B65D 25/40

(52) U.S. Cl. 220/713; 220/714; 222/145.5; 222/566

(57) ABSTRACT

Spill-resistant cups for consuming beverages with delivery systems for simultaneously dispensing one or more agents which can reduce the rate of beverage-induced tooth decay and/or enamel erosion are disclosed herein. In one embodiment, the spill-resistant cup can include a hollow cup body defining a beverage holding chamber. The spill-resistant cup also includes a lid assembly with a drinking spout having one or more spaced-apart drinking holes. The drinking spout is configured to be engaged by a consumer's mouth. The lid assembly can positively engage the cup body to enclose the beverage holding chamber. The spill-resistant cup can also include an agent delivery system for controlled delivery of the active ingredient to the consumer's mouth. Further, the spill-resistant cup can include a flow control element configured to limit a flow rate of the beverage from the beverage holding chamber to the drinking holes disposed in the drinking spout.

### CROSS-REFERENCE OF RELATED APPLICATION

The present application claims priority to U.S. Provisional Application Ser. No. 60/914,662, filed Apr. 27, 2007, entitled SUPER SIPPY CUP, the disclosure of which is incorporated herein by reference in its entirety.

### TECHNICAL FIELD

The present disclosure is directed toward cups and other liquid containers, and more particularly to non-spill cups, including children's “sippy” cups that dispense contents from a spout.

### BACKGROUND

When a child drinks a beverage, the child's teeth are temporarily bathed in the beverage. Tooth enamel is a very hard, protective layer on the outside of teeth made up of hydroxyapatite. In the presence of acid, hydroxyapatite slowly dissolves into calcium and phosphate, a process called demineralization. Saliva promotes the reformation of hydroxyapatite, i.e., the remineralization of enamel. These processes are always in a state of flux. When demineralization occurs at a rate greater than that of remineralization, the enamel can be irreversibly lost, making the tooth susceptible extreme decay and loss.

Oral cavity acids can be produced by plaque bacteria, as well as from the consumption of foods and beverages. Acids formed by plaque bacteria result in enamel (tooth) decay, while the foods/beverages with low pH cause enamel erosion. These processes are described further below.

Plaque, which is located on the surface of enamel, is formed and inhabited by bacteria such as cariogenic Streptococcus mutans and Lactobacillus. Cariogenic bacteria that form plaque on the surface of the teeth ferment simple sugars and starches from food into acids. The acids can accumulate in the plaque long enough to lower the pH which can demineralize the enamel (i.e., a calcium-phosphorous mineral known as hydroxyapatite) underlying the plaque formations. Repeated and prolonged acid challenges on the enamel results in localized loss of enamel and the formation of dental caries below the plaque. This process is enamel (or tooth) decay.

Naturally produced saliva continually rinses and promotes plaque removal, inhibits bacterial growth and demineralizes tooth enamel. Teeth integrity and gum health, the species of bacteria inhabiting the oral cavity, the formulation and flow rate of saliva, and the repeated and/or prolonged exposure to simple sugars (e.g., glucose, sucrose, fructose, etc.) and starches, all play major roles in determining teeth enamel's susceptibility to demineralization.

The process of enamel/tooth decay can be a common and chronic disease of childhood, even in developed countries. The condition is known as Early Childhood Caries (“E.C.C.”). Repeated and prolonged use of bottles and sippy cups can promote tooth decay and E.C.C. Sucking fluid from a bottle nipple or sippy cup spout can result in beverage accumulation behind the upper lip and around the front teeth. This micro environment dilutes the surrounding saliva and prolongs the time sugar is exposed to the plaque and inhabiting bacteria. E.C.C. typically occurs on the upper incisors and, when severe, extends to the surrounding teeth. It can occur soon after the baby teeth erupt and damage can be quite extensive. Manifestations of it include pain, infection, abscesses, chewing difficulty, poor speech articulation and an increase risk of caries in the permanent teeth.

Enamel erosion is the loss of enamel resulting from repeated and prolonged exposure to high concentrations of acid. When the source of acid is external, i.e., consumed, it's called extrinsic enamel erosion. The most commonly consumed highly acidic foods are citric juices and carbonated beverages, both of which are consumed by children from sippy cups. Erosion frequently attacks the backside of the upper front teeth because these surfaces endure prolonged contact with the acidic beverages.

Accordingly, both E.C.C. and extrinsic enamel erosion result from the repeated and prolonged consumption of acidic liquids which can cause extensive demineralization and destruction of enamel, especially in the upper front teeth.

Spouted, non-spill “sippy” cups allow children to drink without spilling. They have become very popular since their introduction in the 1980s. Without the worry of spills, and wanting to satisfy their child's requests for something to drink, many parents allow their children to have at-will access to beverages throughout the day. The presence of cup holders in cars, car seats and strollers is a reflection of their popularity and availability. Frequent and prolonged consumption of acidic or sugar-containing beverages from these cups throughout the day put children's teeth at risk for decay and/or erosion. For example, these beverages can include sweetened drinks, fruit juices, soda, carbonated flavored water, milk, etc.

### SUMMARY

The present disclosure is directed generally toward cups and other liquid containers, and more particularly non-spill cups configured to deliver a beverage and a selected active ingredient or other agent when the user consumes the beverage. One aspect of the disclosure is directed to a cup for administering an active ingredient for teeth protection. In one embodiment, a spill-resistant cup comprises a cup body defining a chamber configured to contain a beverage, and a lid assembly having a drinking spout with one or more drinking holes. An agent delivery system is couplable to the lid assembly and is in fluid communication with the spout. The agent delivery system is configured for controlled delivery of the active ingredient substantially simultaneously with delivery of an initial portion of the beverage. The agent delivery system has an agent retaining portion that retains the active ingredient in a position separate from the beverage and in a position for delivery with the initial portion of the beverage. A flow control element is coupled to the lid assembly and configured to block the beverage from spilling out of the spout.

Another aspect of the disclosure is directed toward a spill-resistant cup including a cup body that defines a beverage holding chamber, a lid assembly releaseably attached to the cup body, a spout coupled to the lid assembly, a flow control element for separating the beverage holding chamber from at least a portion of the spout, and an agent delivery system having an agent dispenser for dispensing an agent in a rate-controlled manner into the spout for delivery with an initial portion of the beverage, wherein the agent includes an active ingredient for protecting tooth enamel from demineralization.

Another aspect of the disclosure is directed toward a spill-resistant cup for administering an active ingredient for teeth protection. The spill-resistant cup includes a cup body defining a beverage holding chamber, a lid portion releaseably attached to the cup body, a spout coupled to the lid portion, a flow control element separating the beverage holding chamber from at least a portion of the spout, and a dissolvable formulation of the active ingredient positioned between the flow control element and drinking holes in the spout. The formulation is configured to dissolve at a dissolution rate when contacted by the beverage flowing through the flow control element.

A further aspect of the disclosure is directed toward a lid assembly usable with a spill resistant cup for administering an active ingredient to a user for teeth protection. The lid assembly comprises a lid portion having a drinking spout, and an agent delivery system couplable to the lid portion and in fluid communication with the chamber in the cup. The agent delivery system is configured for controlled delivery of the active ingredient to the user's mouth substantially simultaneously with delivery of an initial portion of the beverage. The agent delivery system has an agent retaining portion that retains the active ingredient in a position separate from the beverage and in a position for delivery to the user's mouth with the initial portion of the beverage. A flow control element is coupled to the lid assembly and configured to block the beverage from spilling out of the spout.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings. Understanding that these drawings depict only typical embodiments of the disclosure and are not therefore to be considered to be limiting of its scope, the disclosure will be described and explained with additional specificity and detail through the use of the accompanying drawings.

FIG. 1 is an isometric view illustrating a spill-resistant cup in accordance with an embodiment of the present disclosure.

FIG. 2A is a partially schematic isometric view of the spill-resistant cup of FIG. 1 illustrating an agent delivery system in accordance with an embodiment of the present disclosure.

FIG. 2B is a top view illustrating a flow control element in accordance with an embodiment of the present disclosure.

FIG. 3 is a partially schematic isometric view of the spill-resistant cup of FIG. 1 with the lid assembly removed from the hollow cup body and illustrating the agent delivery system having an agent dispenser receivable in a cup body receptacle in accordance with an embodiment of the present disclosure.

FIG. 4 is a partially schematic isometric view of the spill-resistant cup of FIG. 1 with a lid assembly removed from a hollow cup body and illustrating the agent delivery system having an agent dispenser coupled to the lid assembly in accordance with an embodiment of the present disclosure.

FIG. 5 is a partially schematic isometric view illustrating a hollow cup body having a cup body receptacle and a plurality of agent dispensers in accordance with another embodiment of the present disclosure.

FIG. 6A is a partially schematic cross-sectional side view of a lid assembly illustrating a drinking spout having an agent mixing chamber in accordance with an embodiment of the present disclosure.

FIG. 6B is partially schematic cross-sectional side view of a lid assembly illustrating a drinking spout having an agent mixing chamber in accordance with another embodiment of the present disclosure.

FIG. 6C is partially schematic cross-sectional side view of a lid assembly illustrating a drinking spout having an agent mixing chamber in accordance with another embodiment of the present disclosure.

FIG. 7 is partially schematic cross-sectional side view of a lid assembly illustrating a drinking spout having an agent mixing chamber for receiving an agent in a dissolvable formulation in accordance with another embodiment of the present disclosure.

FIG. 8 is a partially schematic side view of a spill-resistant cup illustrating an agent delivery system in accordance with another embodiment of the present disclosure.

FIGS. 9A and 9B are bottom and isometric top views, respectively, of a lid assembly illustrating the agent delivery system of the spill-resistant cup of FIG. 8 in accordance with an embodiment of the present disclosure.

FIG. 9C is partially schematic cross-sectional side view of a lid assembly illustrating an orthodontic drinking spout having the agent delivery system of the spill-resistant cup of FIG. 8 in accordance with another embodiment of the present disclosure.

FIGS. 10A and 10B are partially schematic side views of a spill-resistant cup illustrating further embodiments of an agent delivery system having a plurality of agent dispensers in accordance with the present disclosure.

FIGS. 11A and 11B are partially schematic cross-sectional side views of a lid assembly illustrating a drinking spout and an orthodontic drinking spout, respectively, having an integrated agent dispenser in accordance with additional embodiments of the present disclosure.

FIG. 12 is a partially schematic side view illustrating a spill-resistant cup and an agent refill container for filling an agent dispenser of an agent delivery system in accordance with an embodiment of the present disclosure.

FIG. 13 is a partially schematic cross-sectional side view of a spill-resistant cup illustrating an agent delivery system in accordance with another embodiment of the present disclosure.

FIG. 14 is side view illustrating a lid assembly with a drinking spout having an agent in a dissolvable formulation on an outer surface of the spout in accordance with an embodiment of the present disclosure.

FIG. 15 is a side view illustrating a spill-resistant cup in accordance with another embodiment of the present disclosure.

FIG. 16A is an isometric view illustrating a spill-resistant bottle having a drinking spout in accordance with an embodiment of present disclosure.

FIG. 16B is an exploded partially schematic isometric view of the drinking spout of FIG. 16A illustrating an agent delivery system in accordance with an embodiment of the present disclosure.

FIG. 16C is a partially schematic top view illustrating the drinking spout of FIG. 16B having one or two agent dispensers in accordance with embodiment of present disclosure.

FIGS. 17A and 17B are partially cut away, top isometric views of a lid assembly in accordance with another embodiment of the present disclosure.

FIGS. 18A-C are schematic isometric views of a lid assembly in accordance with another embodiment of the present disclosure.

FIG. 19A is a schematic, exploded isometric view and FIG. 19B is a cross-sectional view of a lid assembly in accordance with another embodiment of the present disclosure.

### DETAILED DESCRIPTION

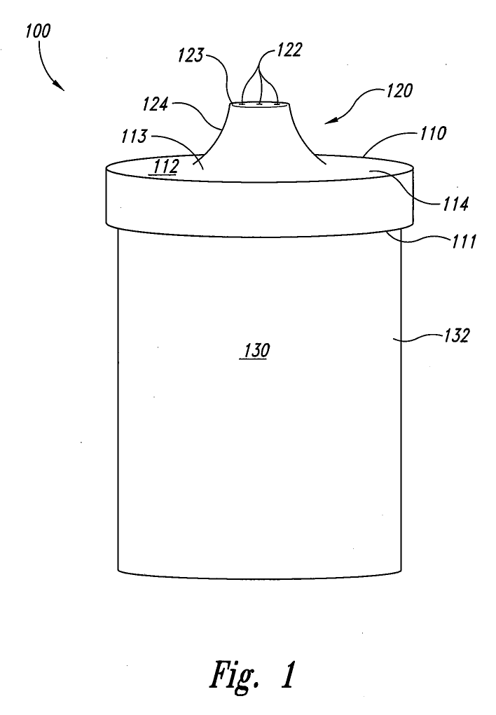

The present disclosure describes embodiments of spill-resistant cups for providing and dispensing agents, such as teeth enamel protecting and rebuilding agents. Several specific details of the disclosure are set forth in the following description and in FIGS. 1-16C to provide a thorough understanding of certain embodiments of the disclosure. One skilled in the art, however, will understand that the present disclosure may have additional embodiments, and that other embodiments of the disclosure may be practiced without several of the specific features described below.

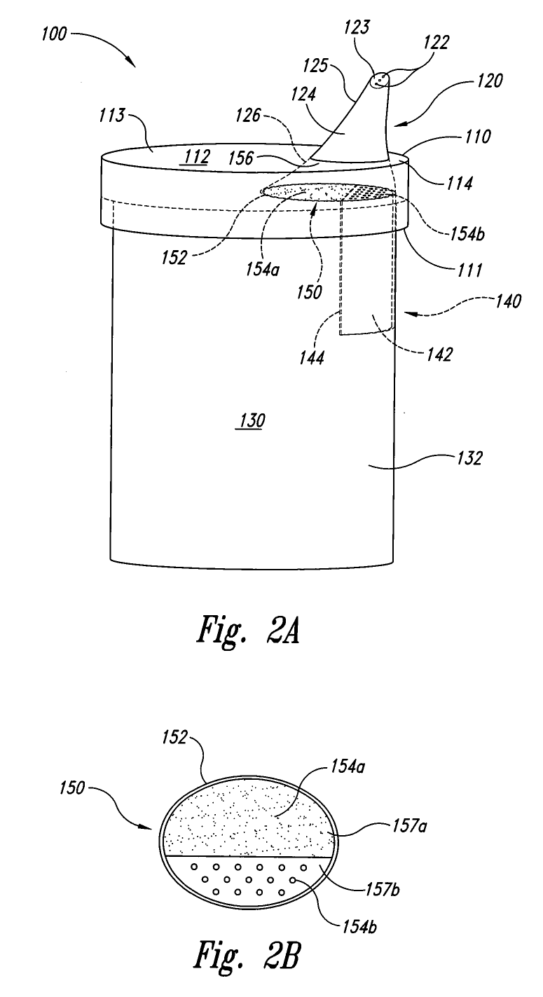

FIG. 1 is an isometric view and FIG. 2A is a partially schematic isometric view illustrating a cup 100 in accordance with an embodiment of the present disclosure. While the illustrated embodiment is shown with a spill-resistant cup, other embodiments can include a bottle or other beverage receptacles. Referring to FIGS. 1 and 2A together, the spill-resistant cup 100 includes a lid assembly 110 having beverage outlet, referred to herein as a drinking spout 120, a hollow cup body 130 configured to contain a primary beverage and an agent delivery system 140. The lid assembly 110 has a lid portion 113 that positively engages the cup body 130, for example with a threaded inside surface (not shown) that mates with a threaded upper outside surface (not shown) of the cup body 130, thereby closing a beverage holding chamber 132 formed by the hollow cup body 130. In other embodiments, the lid portion 113 and cup body 130 can be positively engaged and connected, such as by pressing a bottom edge 111 of the lid assembly 110 over a top ridged portion of the cup body 130. A sealing gasket can be included to prevent the primary beverage from leaking between the lid assembly 110 and the cup body 130.

In the illustrated embodiment, the drinking spout 120 extends from a top surface 112 of the lid portion 113 and is positioned along or generally adjacent to a lid edge 114. In some embodiments, the spout 120 can be ergonomically shaped and/or angled toward the lid edge 114 so a user's mouth can positively engage the spout when drinking a beverage from the spill-resistant cup 100. The drinking spout 120 includes one or more drinking holes 122 for allowing a primary beverage and/or agent to pass through the drinking holes 122. In one embodiment, the drinking holes 122 can be at a terminal end 123 of the spout 120. In other embodiments, the drinking holes 122 can be positioned at one or more sites around a spout projection 124. In one embodiment, one or more drinking holes 122 can be located on a palette side 125 (e.g., towards the roof of an engaged mouth) of the drinking spout 120.

In one embodiment, the lid portion 113 and the drinking spout 120 can be integrally connected and formed as a single unit. The hollow cup body 130 can be formed as a unit separable from the lid assembly 110. In a further embodiment, the drinking spout 120 can be formed separately from the lid portion 113 and can be permanently or temporarily attached to the lid portion 113. In one embodiment, the drinking spout 120 can be a disposable mouthpiece or it can include a disposable portion, such as the portion physically engaged by the user's mouth while drinking. A blow-molding process, in which hollow plastic parts can be formed, can be used to manufacture such embodiments. In a further embodiment, an injection molding process or other manufacturing process can be used to manufacture some or all of the lid assembly 110 and/or the cup body 130.

While these molding processes are suitable for a spill-resistant cup 100 made from plastics, such as non-breakable, dishwasher and/or microwave-safe thermoplastics (e.g., polymethylpentene, polyethylene, polypropolyene etc.), other manufacturing processes can be used as well as variety of materials (e.g., ceramics, paper, biodegradable organic materials, etc.). Furthermore, in some embodiments, the materials used to form the lid assembly 110 and the cup body 130 can be the same or different. For example, the lid assembly 110 can be a reusable plastic material and the cup body 130 can be a paper or other disposable organic material. In another embodiment, the lid assembly can be made of a disposable and/or recyclable material.

The lid assembly 110 in one embodiment has a flow control element 150 configured to limit a flow rate of a primary beverage from the beverage holding chamber 132 to the drinking holes 122 in the spout 120. In some embodiments, the flow control element 150 prevents beverage flow from the chamber 132 to the spout 120 under non-drinking/non-sucking conditions (i.e., providing a spill-resistant quality to the cup 100). For example, the beverage will not flow past the flow control element under gravitational forces alone. A user, such as a child or other consumer of the beverage, can suck on the spout 120 to provide negative pressure in the cup 100 to draw the primary beverage from the cup's chamber, past the flow control element and out through the spout into the user's mouth.

In one embodiment, the flow control element 150 is a membrane 152 having one or more spaced-apart apertures 154, such as pinholes or slits. In one embodiment, the membrane 152 is formed from a resilient, elastomeric material (e.g., pliable rubber, thermoplastic elastomer, silicone, etc.) in which the apertures 154 can close and/or temporarily seal when the cup 100 is not in use. In contrast, when a user sucks on the spout 120, the membrane 152 can stretch or otherwise deform, thereby causing one or more apertures 154 to open and permit fluid to flow from the chamber 132 to the spout 120 in a rate-controlled manner. Likewise, slits disposed in the membrane 152 can be in a closed position when the cup is not in use, and when a sucking action provides a change in applied differential pressure, the slit(s) can open to allow the primary beverage to pass from the chamber 132 to the drinking spout 120 in a rate controlled manner. In other embodiments, however, the flow control element 150 can be a one-way valve or other gravity-fed and/or pressure-operated fluid passage mechanism.

The spill-resistant cup 100 includes the agent delivery system 140 configured to dispense into the user's mouth a selected active ingredient along with the primary beverage to, as an example, protect and/or remineralize the user's teeth, including the tooth enamel. Protective and/or remineralizing agents that can be used with the spill-resistant cup 100 can be effective at reducing the rate of tooth decay, and/or reducing enamel erosion. These tooth protective and/or remineralizing agents can be effective, for example, when they are on or near the teeth during an acid challenge as explained above. In some embodiments, the agents are maintained separate from the primary beverage and not mixed with the beverage until just before the beverage and agent are sucked, drawn, poured, or otherwise dispensed from the cup 100. In other embodiments, the lid assembly can be configured to keep the agent separate from the primary beverage and so that the agent is delivered to the user's mouth (e.g., in a solution) just before the primary beverage is delivered to the user's mouth. In another embodiment, the lid assembly can be configured to keep the agent separate from the primary beverage and so that the agent is delivered to the user's mouth (e.g., in a solution) simultaneously with the primary beverage via separate and distinct pathways and holes in the lid or spout.

As discussed herein, the agents can include one or more ingredients, including active ingredients, binders, fillers, etc. The agents can be provided so the collection of ingredients are in a stand alone format, such as a tablet or the like that can be handled and manipulated by a user. For example, the agent in tablet format can be handled by a user and loaded into the cup's agent delivery system just before the cup will be used for drinking a beverage of choice. In other embodiments, the agents can include an agent carrier that contains or retains the ingredients (e.g. an active ingredient) and that can be handled by a user for loading it into the agent delivery system. For example, the agent can include a gel carrier forming a gel strip or the like, a cartridge, a perforatable or rupturable capsule or vessel, or other carriers that carry the active ingredients in a format that can be handled, packaged, stored, and/or otherwise manipulated before or during the process of loading the agent delivery system.

The agents, including active ingredients and formulations include one or more active ingredient(s) known now or in the future, such as agents that inhibit enamel decay or erosion, the growth and/or metabolism of cariogenic bacteria, and/or promotes enamel remineralization and strengthening. The agents in other embodiments can include other orally administered ingredients, active ingredients and formulations for, as an example, therapeutic or diagnostic medicaments, supplements, or other additives. The agents can be stored and/or delivered in a variety of formulations (e.g., liquid, gel, paste, dissolvable solid, powder) depending on their storage and/or reaction-dependent conditions. Furthermore, the dose and/or relative amount of the agent delivered with the primary beverage to the user via the agent delivery system 140 can be an efficacious dose of the agent depending on a variety of factors including the agent type, the user's age/weight/tolerance, the amount of primary beverage to be consumed, etc.

Remineralization of the tooth enamel is controlled by oral pH and the availability of calcium and phosphate ions present in the mouth; therefore, in one embodiment, rebuilding of enamel can be sped up and/or demineralization can be prevented by the extrinsic addition of these ions. In a specific example, amorphous calcium phosphate (ACP) is a precipitated calcium and phosphate complex that undergoes further reaction to form hydroxyapatite. Accordingly, deposition of ACP on the surface of the teeth can remineralize the tooth enamel. Due to their reactive nature, calcium and phosphate ions can be stored separately until they are applied to the tooth surface.

In another embodiment, the agent can include phosphoproteins, such as those found in milk (e.g., casein phosphopeptides). These agents may inhibit demineralization, promote remineralization, inhibit the growth of cavity-causing bacteria, etc. Specific examples of phosphoproteins can include casein phosphopeptide-amorphous calcium phosphate (CPP-ACP), and calcium glycerophosphate (CGP) which is an odorless and almost tasteless compound provided in a soluble powder formulation.

CPP-ACP, which is referred to as Recaldent® and described in U.S. Pat. Nos. 5,130,123 and 5,227,154, is derived from casein phosphopeptides which are able to bind calcium and phosphate ions and stabilize amorphous calcium phosphate. The casein-peptide-stabilized calcium phosphate particles can diffuse through the tooth surface and provide calcium and phosphate in a soluble form for reacting to form crystalline hydroxyapatite of the tooth enamel where dental caries have begun to form.

In another embodiment, the agent can include fluoride. Fluoride successfully reduced the rate of tooth decay in populations drinking from fluoridated community water at an average concentration of about 0.7-1.2 parts per million. Fluoride, when in direct contact with the teeth, can inhibit enamel demineralization, enhance remineralization of enamel, and inhibit bacterial enzymes and thus acid production via fermentation.

In a further embodiment, the agent can include phosphopeptide-stabilized fluoride. Fluorides can more readily remineralize into fluorapatite in the presence of CPP-ACP or CGP. Because phosphopeptides intensifies fluoride's efficacy, lower doses of fluoride can be used.

In another embodiment, the agent can be Xylitol which is a naturally occurring sugar alcohol used as a sugar substitute. Studies have shown that Xylitol is non-metabolizeable to cariogenic bacteria, and therefore retards demineralization of tooth enamel most likely by attracting and starving cariogenic bacteria. Xylitol may also promote remineralization of tooth enamel by increasing saliva production.

In yet a further embodiment, the agent could be urea which is found normally found in saliva. Urea can diffuse into dental plaque where it can be converted to ammonia and carbon dioxide by a bacterial enzyme. Urea, continuously supplied at concentrations normal for saliva can raise microcosm plaque pH by an amount that could significantly reduce dental caries.

Other agents may also include calcium citrate malate (CCM) which is a highly bioavailable form of calcium, ingestible immunoglobulins—such as those produced by the immune system—to control and prevent infections, and hydrogen peroxide which can also inhibit the growth of cariogenic bacteria in the mouth.

In one embodiment, the spill-resistant cup 100 is configured to dispense all or a majority of the agent into the mouth of the user along with the first or first few drinks of the primary beverage, rather than dispensing the agent during the entire duration that the consumer is drinking the beverage. For example, in at least one embodiment, the lid assembly 110 and the agent delivery system 140 are configured to dispense substantially all of the active ingredient within the first two ounces of the primary beverage consumed by the user. Further, the spout 120 and/or agent delivery system 140 can be configured to generally direct the active ingredient to the teeth before most of the primary beverage in the drink reaches the teeth. Accordingly, the cup 100 can be configured to lay down a protective layer of the active ingredient on the teeth that will protect the teeth for a period of time, including while the user drinks the rest of the beverage. In the illustrated embodiment, the agent delivery system is configured to the agent delivery rate or duration is different than the primary beverage deliver rate or duration.

The agent delivery system can be configured to provide a flow rate relative to the agent so that a desired concentration of the agent is delivered with the beverage to the user's mouth. Accordingly, the agent delivery system can avoid an undesirable elevated concentration level or concentration spike during delivery of the agent to the user. For example, in one embodiment, the flow rate can be controlled as a function of the dissolution rate of the agent in the primary beverage. In another embodiment, a carrier of the agent can be selected and configured to achieve a desired concentration of the agent for delivery with the selected portion of the primary beverage. In other embodiments, the agent delivery system 140 can be configured so the agent is dispensed during the entire course of delivering all of the primary beverage for consumption. In yet other embodiments, the agent can be dispensed sequentially immediately prior to dispensing the beverage into the user's mouth.

Referring to FIG. 2A, the agent delivery system 140 of the illustrated embodiment includes an agent dispenser 142. The agent dispenser 142 can be a cartridge or other separate container configured to carry and separate the agent from the primary beverage within the cup until the consumer begins to drink. In one embodiment, the agent dispenser 142 is a single use vessel that delivers a selected dose of a dry or liquid agent while the user drinks from the spill-resistant cup 100. In another embodiment, the agent dispenser can include multiple doses of the agent for sequential delivery to the user, including over separate drinking events. The agent dispenser 142 can be removable and disposable after the agent is delivered. In other embodiments, the agent dispenser 142 can be refilled with additional agent and reused multiple times. The agent dispenser and the lid assembly can have a lock-and-key configuration, so that only selected agent carriers can be used with selected lid assemblies and/or cups.

In the illustrated embodiment, the agent delivery system 140 also includes an agent dispenser receptacle 144 that removably receives the agent dispenser. With reference to FIG. 2A, the receptacle 144 can be an elongated holding cell attached or otherwise formed in the beverage holding chamber 132 and configured to separate the agent dispenser 142 from a primary beverage held in the chamber 132. In another embodiment, not shown, the receptacle 144 may function as the agent dispenser 142. For example, the receptacle can be permanently fixed or formed within the chamber 132 and the agent (e.g., liquid form, powder form, etc.) may be dispensed into the receptacle prior to beverage consumption. In a further embodiment, the agent delivery system 140 can include an attachment site for the agent dispenser 142 on the lid assembly or the cop body 130, wherein the attachment site is configured for holding the dispenser in a desired position relative to the chamber 132 and the spout 120.

In operation, the agent can be maintained separate from the primary beverage unless mixing before the user drinks the primary beverage is desirable. The agent can be dispensed from the agent dispenser 142 into the user's mouth simultaneous with the delivery of a portion of the primary beverage, such as when a user sucks and/or drinks from the drinking spout 120. In one embodiment, the rate of flow and/or timing of agent release from the dispenser 142 can be controlled by the flow control element 150. As illustrated in the embodiment shown in FIG. 2A, the agent dispenser 142 can be positioned adjacent to the membrane 152 such that agent is released in a rate and volume controlled manner to the user.

In one embodiment, the drinking spout 120 can have an extended portion 126 within the lid assembly 110. The membrane 152 extends over the extended portion 126, such that a mixing chamber 156 is formed within the spout 120 between the drinking holes 122 and the membrane 152. In other embodiments, not shown, the membrane 152 can be extended across other portions of the internal lid assembly 110 to selectively block or control the flow of beverage and/or agent. For example, the membrane 152 may extend over the internal circumference of the lid assembly 110 such that the mixing chamber 156 includes the space between the membrane 152 and the top surface 112 of the lid assembly 110. When the user tips the cup 100 and sucks on the drinking spout 120 to drink the primary fluid, both the primary beverage and the agent can be directed into the mixing chamber 156 and delivered simultaneously into the user's mouth.

In some embodiments, the flow rate of the primary beverage through the apertures 154 in the membrane 152 can be different from the flow rate of the agent through the membrane 152. FIG. 2B is a top view illustrating the flow control element 150 of FIG. 2A in accordance with an embodiment of the present disclosure. As illustrated, the membrane 152 can have one or more portions 157 for providing different flow rates. For example, the primary beverage can be dispensed through a first portion 157a having a plurality of first sized apertures 154a, and the agent dispenser 142 can be aligned with a second membrane portion 157b having a plurality of second sized apertures 154b.

In one embodiment, the second apertures 154b can be larger than the first apertures 154a such that the agent is dispensed at a faster rate into the mixing chamber 156 prior to delivery of a mixed portion of beverage and agent to the oral cavity of the consumer. Such an embodiment can be used in situations when it may be desirable to have an early and concentrated delivery of agent to the teeth prior to the majority of the primary beverage. In other embodiments, the size and/or relative flow rate from the first and second apertures 154a and 154b can be approximately equal, while in still further embodiments, the agent can be released at a slower rate than the primary beverage. In these embodiments, the agent dispenser 142 may contain more than one effective treatment dose. For example, the agent in the agent dispenser 142 may be dispensed to the user while drinking more than one beverage from the same spill-resistant cup 100.

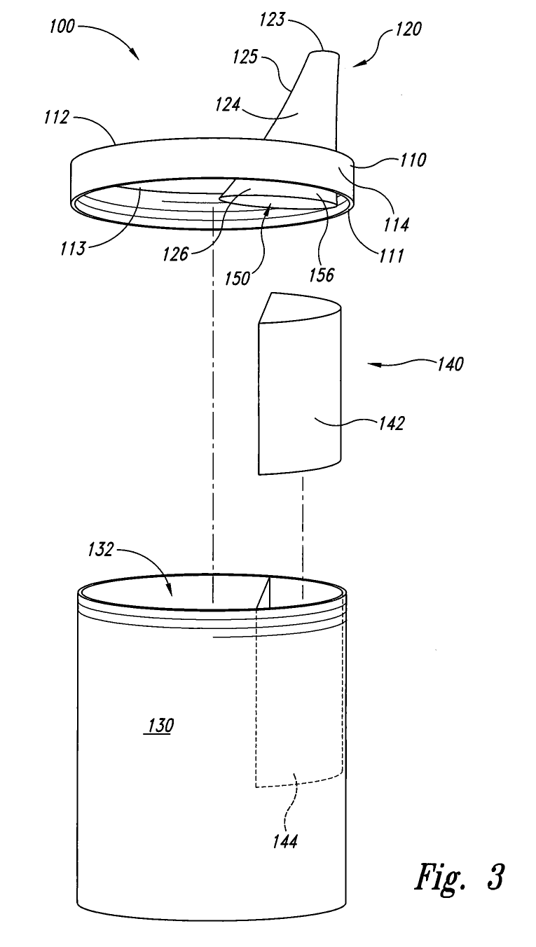

FIG. 3 is a partially schematic isometric view of the spill-resistant cup 100 illustrated in FIG. 2A with the lid assembly 110 removed from the cup body 130 and illustrating the agent delivery system 140 having the agent dispenser 142 receivable in the receptacle 144 in accordance with an embodiment of the present disclosure. In operation, a user preparing a beverage in the cup 100 can insert the agent dispenser 142 (e.g., in the form of a cartridge holding liquid, gel, or powder formulations of the agent) when the lid assembly is disengaged (i.e., unscrewed) from the cup body 130.

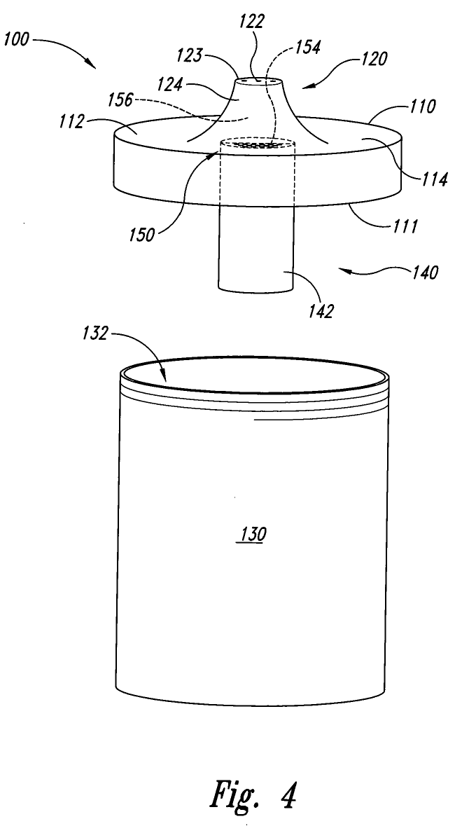

In another embodiment, the agent delivery system 140 does not include a receptacle in the cup body 130. For example, FIG. 4 is a partially schematic isometric view of the spill-resistant cup 100 of FIG. 2A with the lid assembly 110 removed from the cup body 130 and illustrating the agent delivery system 140 having the agent dispenser 142 directly coupled to the lid assembly 110 in accordance with an embodiment of the present disclosure. In operation, a user preparing a beverage in the cup 100 can insert the agent dispenser 142 (e.g., in the form of a cartridge or other self-contained insert) to the lid assembly such that the dispenser is aligned with the flow control element 150 below the mixing chamber 156. Once the agent dispenser 142 is coupled to the lid assembly 110, the lid assembly can engage the cup body 130. In this embodiment, the agent dispenser 142 can be within the beverage holding chamber 132 while maintaining a physical separation between the primary beverage in the chamber 132 and the agent until the user begins to drink the beverage.

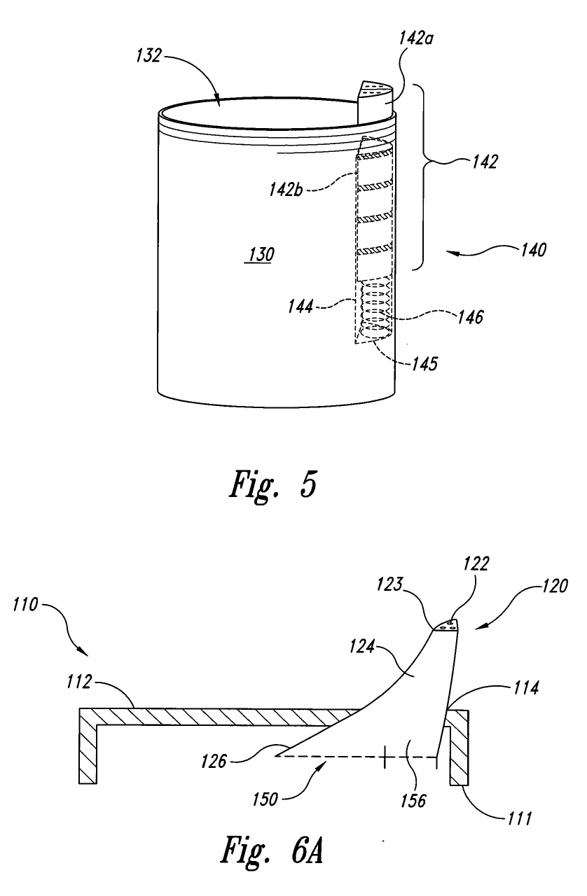

FIG. 5 is a partially schematic isometric view illustrating the cup body 130 including the receptacle 144 for holding the agent dispenser 142 in accordance with another embodiment of the present disclosure. In the illustrated embodiment, the receptacle 144 or other portion of the cup body 130 can be configured to receive a plurality of agent dispensers 142. The plurality of agent dispensers 142 can include one or more doses of agent to be dispersed to the user during drinking of a beverage. In a specific example, the individual agent dispensers 142 can include a selected volume of agent for disbursement during a single beverage consumption period.

As illustrated in FIG. 5, the plurality of agent dispensers 142 can be inserted in the receptacle 144 during a preparation of a first beverage. The agent in the top-most agent dispenser 142a can be dispensed during the consumption of the first beverage. During preparation of a second beverage, a user preparing the beverage can remove the top-most agent dispenser 142a to expose a second agent dispenser 142b to the flow control element 150 (shown in FIG. 2A). In one embodiment, a spring 146, or other biasing member, can be included in a lower portion 145 of the receptacle 144 to push the upper-most agent dispensers 142 toward the lid assembly 110 such that the selected agent dispenser 142b is proximal to the flow control element 150. Accordingly, the embodiment illustrated in FIG. 5 provides an agent delivery system 140 that can dispense multiple doses of agent during the course of several uses of the spill-resistant cup 100 without the requirement of inserting a new and/or additional agent dispensers 142 with each use.

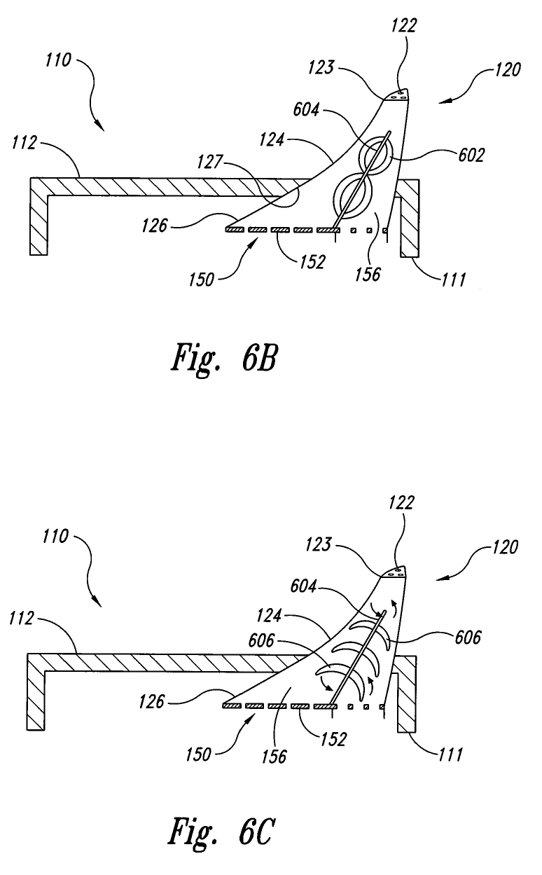

In some embodiments, the agent may be formulated in a liquid, tablet, powder, gel or other formulation that can be mixed, diluted and/or dissolved with a portion of the primary beverage prior to delivery to the mouth and teeth of the user. FIGS. 6A-6C illustrate a plurality drinking spout configurations for mixing an agent formulation with a portion of primary beverage prior to delivery to the mouth.

FIG. 6A is a partially schematic cross-sectional side view of a lid assembly 110 illustrating the drinking spout 120 having the mixing chamber 156 in accordance with an embodiment of the present disclosure. In one embodiment, the spout 120 and mixing chamber 156 are configured to allow a portion of the primary beverage to mix with the agent as the user begins to drink. The drinking holes 122 in the spout 120 can be configured to control delivery rate of the agent and primary beverage to the user's mouth. In another embodiment, a flow control element 150 can be coupled to the extended portion 126 of the drinking spout 120 to control fluid and agent intake and/or delivery. The mixing chamber 156 is configured to allow a portion of the primary beverage and agent to swirl and/or mix prior to being dispensed through the drinking holes 122 into the user's mouth. The selected delivery rate may be determined by the solubility of the agent into the beverage and/or the desired concentration of the agent for optimum delivery to the user's mouth. Accordingly, different delivery rates may be used for cups designed or used for use with different agents.

FIG. 6B is partially schematic cross-sectional side view of the lid assembly 110 illustrating the drinking spout 120 having a mixing chamber 156 in accordance with another embodiment of the present disclosure. As illustrated, the mixing chamber 156 includes one or more spiral-shaped mixing members 602 positioned around an axis 604. The mixing members 602 can direct the flow of primary beverage and agent dispensed past the flow control element 150 (e.g., the membrane 152) in a circular and/or swirling pattern as the user's sucking action pulls the mixture toward the drinking holes 122. The circular and/or swirling motion can result in more uniform mixing and/or dissolving of the agent in an initial portion of the primary beverage while within the mixing chamber 156 to provide a mixture with a selected concentration of the agent therein prior to being delivered to the user's mouth. In one embodiment the axis 604 is defined by a pin or other axle structure configured to allow the mixing members 602 to rotate or otherwise control the fluid flow through the mixing chamber. In other embodiments, the mixing members 602 can be formed and/or coupled to the inside surface 127 of the spout projection 124.

FIG. 6C is partially schematic cross-sectional side view of the lid assembly 110 illustrating the drinking spout 120 having the mixing chamber 156 in accordance with another embodiment of the present disclosure. As illustrated in FIG. 6C, the mixing chamber 156 includes one or more rotatable mixing blades 606 positioned around the axis 604. The mixing blades 606 can be shaped and positioned off-set from one another such that a sucking action on the drinking spout 120 provides an applied pressure differential that causes an inlet of primary beverage and agent into the mixing chamber. The flow of the portions of the beverage and the agent in the chamber is forced into the mixing blades 606 causing the mixing blades to rotate in a circular manner about the axis 604. The rotation of the mixing blades 606 can cause the swirling motion within the mixing chamber, thereby resulting in more uniform mixing and/or dissolving of the agent within the mixing chamber 156 for delivery to the user's mouth in a desired dosage and concentration.

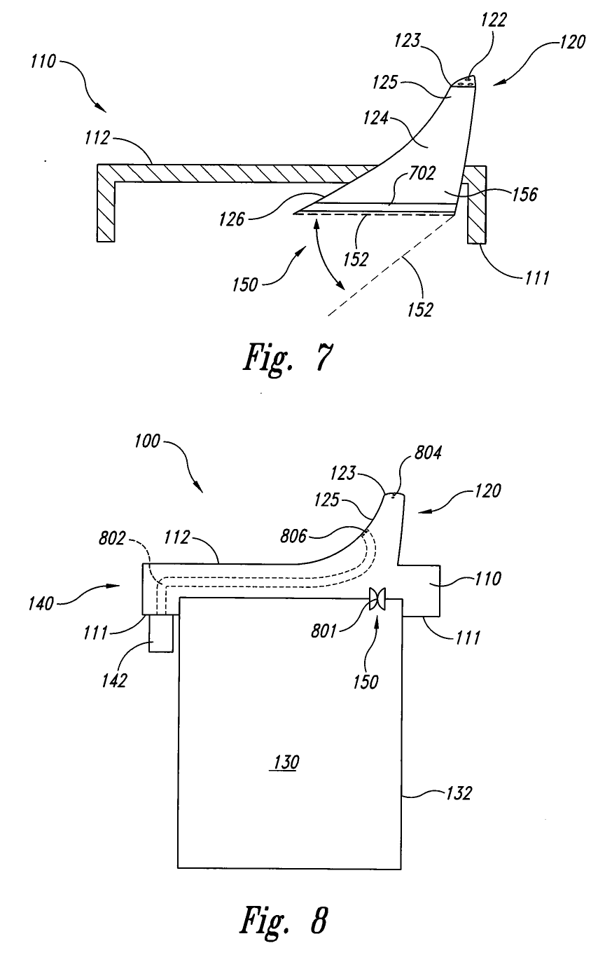

FIG. 7 is partially schematic cross-sectional side view of the lid assembly 110 illustrating the drinking spout 120 having the mixing chamber 156 for receiving an agent in a dissolvable formulation in accordance with another embodiment of the present disclosure. In this embodiment, the agent can be provided in a readily dissolvable formulation such as a solid or gel formulation 702 that can be positioned and/or applied within the mixing chamber 156 prior to directing the primary beverage there through to the user's; mouth. In one embodiment, the agent is coupled with a carrier (i.e., a gel strip) or a binder that allows the agent to be handled by a user, such as when the user is loading the agent into the lid assembly 110 or other portion of the cup.

As illustrated in FIG. 7, the lid assembly 110 is configured so the flow control element 150 can be removed and/or rotated to expose a portion of the mixing chamber 156. The agent can be placed or applied to a receiving portion coupled to the inner surface of the flow control element 150 to securely hold the agent in a selected position. Accordingly, when the user begins to drink the beverage, the flow of beverage passes over the agent and carries the agent through the spout into the user's mouth. In other embodiments, the agent can positioned or applied in other positions within the mixing chamber 156, followed by replacement of the flow control element 150 to the original position. In operation, as the user tips the cup and/or sucks on the spout, the resulting differential pressure will draw a portion of the primary beverage into the mixing chamber 156 through the flow control element 150. As the beverage flows into the mixing chamber 156, the portion of the beverage flows over the agent, and the agent will dissolve (e.g., at a predetermined and/or desired dissolution rate) into the beverage liquid or be carried with the portion of the beverage in a particulate suspension for delivery with the beverage through the drinking holes 122.

The embodiments discussed above provide the mixing chamber 156 within the lid assembly 110 such that an initial portion of the primary beverage can be pre-mixed with some or the entire dose of agent prior to delivery of the agent and/or beverage to the mouth. In other embodiments, however, it may be desirable to prevent or limit mixing of the primary beverage with the agent prior to delivery to the mouth. Several of the agent delivery systems described below dispense the agent into the mouth at or near the end of the spout 120 at the palette side 125 such that the agent is primarily delivered to the mouth region near the front teeth where many children form plaque and tooth decay. Accordingly, the agent can provide a layer of material delivered to the teeth that generally blocks the primary beverage from getting to the teeth before the agent reaches the teeth.

FIG. 8 is a partially schematic side view of a spill-resistant cup 100 illustrating an agent delivery system 801 in accordance with another embodiment of the present disclosure. As illustrated, the primary beverage can be held in the beverage holding chamber 132 provided by the cup body 130. As described above, applied differential pressure to the spout 120 and/or a flow control element 150 (e.g., a one-way valve 801), such as during sucking, allows the primary beverage to flow from the beverage holding chamber 132 through the drinking spout 120.

In the illustrated embodiment, the agent dispenser 140 can be temporarily and/or permanently coupled to the lid assembly 110 at or near the side of the cup 100. The agent dispenser 142 is in fluid communication with the drinking spout 120 via an agent conduit 802 formed and/or provided within the lid assembly 110. As illustrated, the agent can be stored in the agent dispenser 142 connected at or near the bottom edge 111 of the lid assembly 110. The agent, as dispensed, can travel through the conduit 802 on an underside of the lid assembly 110 to be gravity fed and/or sucked through the drinking spout 120.

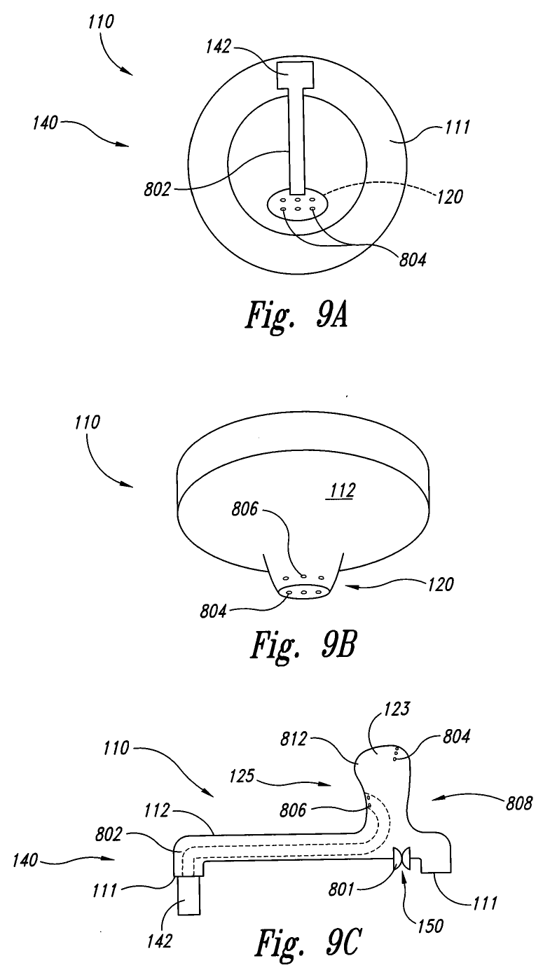

In one embodiment, the drinking spout 120 can have both primary holes 804 for consuming the beverage and secondary holes 806 for dispensing the agent. FIGS. 9A and 9B are bottom and isometric top views, respectively, of a lid assembly 110 illustrating the agent delivery system 801 of the spill-resistant cup 100 of FIG. 8 in accordance with an embodiment of the present disclosure. Referring to FIGS. 8 and 9A-9B together, secondary holes 806 in the spout 120 can be the same size, or a different size than the primary holes 804. In the illustrated embodiment, the secondary holes 806 are located on the palate side 125 of the spout 120; however in other embodiments, may also be located anywhere on the spout 120 to increase the distribution and flow of the agent into the mouth to bathe the teeth.

As one feature of a spill-resistant cup is to prevent inadvertent spills of the primary beverage, care must be taken to also prevent inadvertent leakage or dripping of the agent. Prevention of unintentional dripping of the agent (e.g., in liquid or gel formulations, loose powder formulation, etc.) can include providing valving, such as one or more valves at the secondary holes, in the spout, or in the conduit, which allow for only one-way flow. Such embodiments allow the agent, as an example, to flow from the conduit 802 through the spout to the user's mouth, but prevent the in-flow of liquids or matter from outside the spout 122 into the conduit 802. In other embodiments, the spout can include secondary holes 806 large enough to allow agent to pass through, but small enough to prevent droplet formation so as to avoid inadvertent leakage of the agent.

FIG. 9C is partially schematic side view of the lid assembly 110 illustrating an orthodontic-shaped drinking spout 808 having the agent delivery system 801 of the spill-resistant cup 100 of FIG. 8 in accordance with another embodiment of the present disclosure. The orthodontic-shaped drinking spout 808 can also provide one or more spaced apart primary holes 804 for consuming the beverage and one or more spaced apart secondary holes 806 for dispensing the agent in a manner similar to that described above with respect to FIGS. 8 and 9A-9B.

The illustrated orthodontic-shaped drinking spout 808 can also have an extended and rounded portion 812 on the palette side 125 of the spout 808. The orthodontic-shaped drinking spout 808 can create a barrier between the back-side of the front teeth and the remainder of the mouth during sucking. This barrier can separate the primary beverage, dispensed from the primary holes 804 at the terminal end 123 of the spout 808 (FIG. 9C), from the agent dispensed from the palette-oriented secondary holes 806 towards the teeth. Accordingly, the orthodontic-shaped drinking spout 808 can prevent dilution of the agent at or near the teeth.

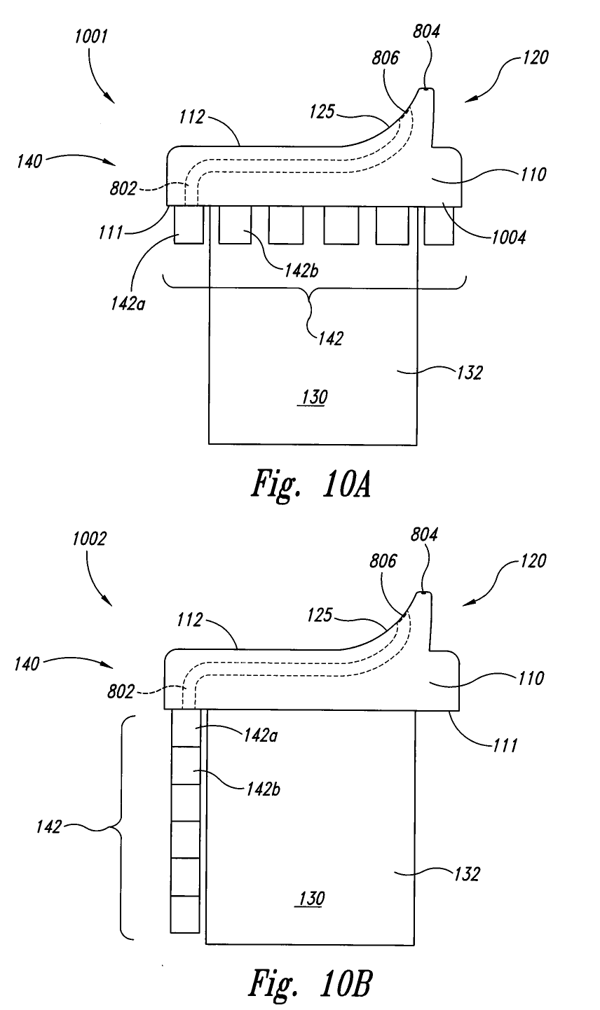

FIGS. 10A and 10B are partially schematic side views of a spill-resistant cup 100 illustrating embodiments of an agent delivery system 1001 having a plurality of agent dispensers 142 for multiple-beverage consumption in accordance with the present disclosure. The agent delivery systems 1001 and 1002 illustrated in FIGS. 10A and 10B, respectively, are similar to the agent delivery system 801 illustrated in FIG. 8; however, the systems 1001 and 1002 provide the plurality of agent dispensers 142 connected to the lid assembly 110.

FIG. 10A illustrates an embodiment in which the plurality of agent dispensers 142 are spaced apart along an adjustable member, such as a rotatable ring 1004, positioned on the bottom edge 111 of the lid assembly 110. In this embodiment, the first agent dispenser 142a can be positioned to be in fluid communication with the secondary holes 806 via the agent conduit 802 for dispensing of agent with a first beverage. In preparation of consuming a second beverage loaded into the cup, a user can rotate the ring 1004 to position the second agent dispenser 142b to align with the conduit 802. Upon consuming the agent from the remainder of the agent dispensers along the ring 1004, the user can remove and replace the ring 1004 with a new ring having multiple filled agent dispensers 142. In another embodiment, the ring 1004 can be removed from the lid assembly 110 and the user can refill the agent dispensers 146 such that the ring 1004 can be reused.

In another embodiment, the agent delivery system 1002 of FIG. 10B includes a plurality of agent dispensers 142 connected to one another and to the lid assembly 110 such that the dispensers are aligned vertically along the cup body 130. In one embodiment, the dispensers 142 can each dispense a premeasured amount of agent desirable for consumption with a single beverage. In operation, a user, when preparing a second beverage, can detach the plurality of agent dispensers 142, remove the top-most dispenser 142a and reattach the plurality of dispensers 142 such that the second dispenser 142b is aligned and in communication with the agent conduit 802. The agent dispensers 140 can be disposable, and such that they can be reused. In other embodiments the dispensers 140 can be refillable and reusable.

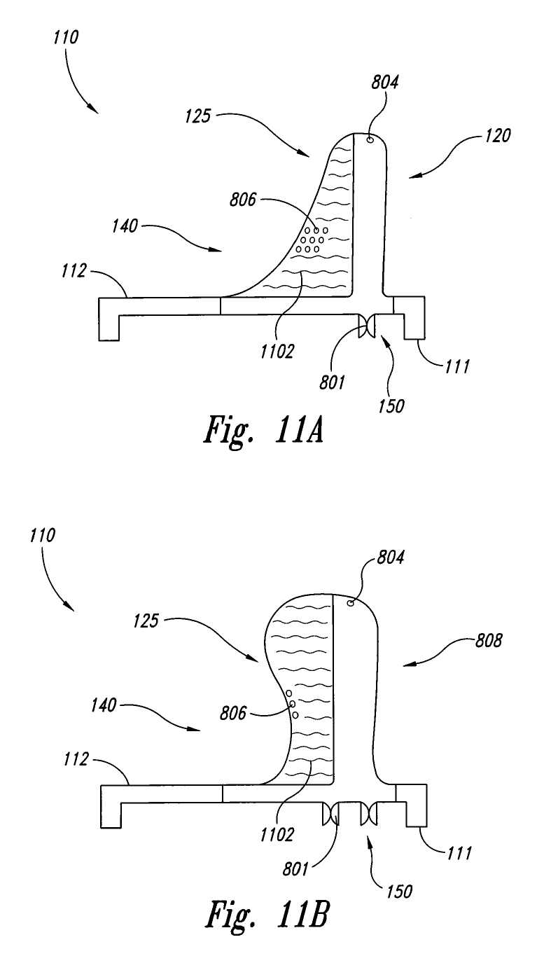

FIGS. 11A and 11B are partially schematic cross-sectional side views of the lid assembly 110 illustrating the drinking spout 120 and the orthodontic-shaped drinking spout 808, respectively, having an integrated agent dispenser 1102 in accordance with additional embodiments of the present disclosure. As described above with respect to FIGS. 8-10B, secondary holes 806 can be provided, for example on the palette side 125 of the spout 120, 808 for dispensing agent from the integrated agent dispenser 1102 into the mouth. In one embodiment, the spout 120, 808 can be rigid and sucking action on the spout 120, 808 can force agent through the secondary holes 806. In another embodiment, the spout 120, 808 can be pliable and a biting or chewing action of the spout 120, 808 can urge agent from the integrated agent dispenser 1102 through the secondary holes 806.

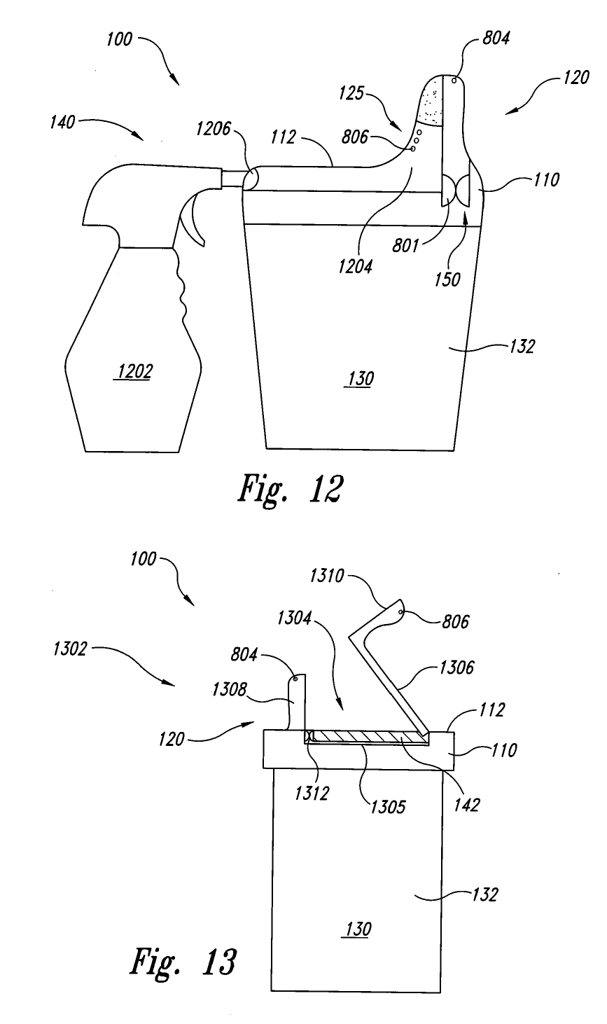

In these embodiments, the agent can be pre-dispensed and/or refilled into the integrated agent dispenser 1102 located within the drinking spout 120, 808. In one embodiment, lid assemblies 110 having integrated agent dispensers 1102 can be disposable following agent depletion from the dispenser 1102. In another embodiment, the integrated agent dispensers 1102 can be refillable through a variety of inlets (not shown) such as nozzle valves, plugged holes, etc. For example, FIG. 12 is a partially schematic side view illustrating a spill-resistant cup 100 and an agent refill container 1202 for filling an integrated agent dispenser 1204 in accordance with an embodiment of the present disclosure. As illustrated, the integrated agent dispenser 1204 can extend beyond the spout 120 to include other portions of the lid assembly 110. The integrated agent dispenser 1204 includes a nozzle inlet 1206 configured to be engaged by the agent refill container 1202 for refilling the dispenser 1204.

FIG. 13 is a partially schematic cross-sectional side view of a spill-resistant cup 100 illustrating an agent delivery system 1302 in accordance with another embodiment of the present disclosure. As illustrated, the lid assembly 110 can include a lid receptacle 1304 for receiving an agent dispenser 142. The lid receptacle 1304 can be accessible by opening and closing a lid cover 1306 on the top surface 112. The drinking spout 120 can include a primary spout portion 1308 for dispensing the primary beverage through the primary holes 804, and a secondary spout portion 1310 for aligning with the agent dispenser 142 received in the lid receptacle 1304 and delivering the agent through secondary holes 806 formed in the secondary spout portion 1310. In one embodiment, the agent dispenser 142 has a rate controlled valve 1312 that allows flow rate of the agent to be controlled as it dispenses from the dispenser 142 into the secondary spout portion 1310.

In other embodiments, not shown, the lid cover 1306 can be positioned on the underneath portion of the lid assembly 110 on a lower side 1305 of the receptacle 1304. Accordingly, in these embodiments, the lid assembly 110 must be disengaged from the cup body 130 to replenish the receptacle 1304 with new and/or additional agent dispensers 142.

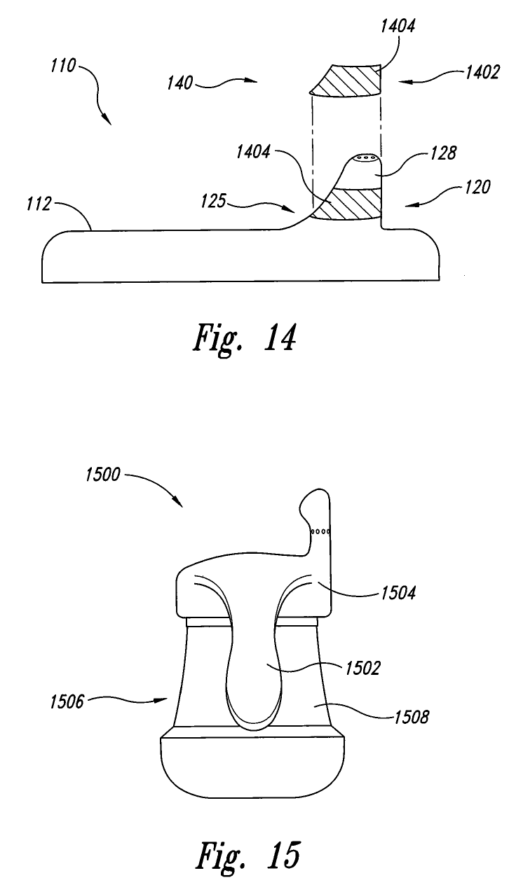

FIG. 14 is side view illustrating a lid assembly 110 with the drinking spout 120 configured to receive an agent in a dissolvable formulation 1402 on an outer surface 128 of the spout 120 in accordance with an embodiment of the present disclosure. In this embodiment, the agent can be provided in a gel or other dissolvable matrix that can be shaped or otherwise applied to the outer surface 128 of the spout 120. Upon contact of the dissolvable formulation 1402 with the liquids and/or saliva present in the mouth, the agent can be released and/or dissolve in a localized manner at or near the surface of the teeth.

In one embodiment, the dissolvable formulation 1402 can be in the shape of a thin ring 1404 configured to surround the outer surface 128 of the spout 120. In other embodiments, the dissolvable formulation 1402 can be thin carrier sheets (not shown) that partially adhere to the outer surface 128 of the spout 120 when applied. Further, the dissolvable formulation 1402 can be freely dispensed from a tube (not shown) or other source by a user on one or more portions of the outer surface 128. In another embodiment, the lid assembly can be configured so the thin ring or sheet can be applied to an inner surface of the spout. For example, the ring or sheet can be in a cartridge format that is quickly and easily pressed into position on the spout prior to the user beginning to drink the primary beverage. The agent will then be delivered to the user when the first portion of the primary beverage is drawn through the spout. After the agent has been fully delivered into the user's mouth, e.g., within the first couple of fluid ounces, the user can simply finish drinking the primary beverage without any additional mixing with the agent.

The spill-resistant cup 100 can include one or more than one of the described agent delivery systems depending on the types (e.g., CCP-ACP, CGP, fluoride, etc.) and formulations (e.g., liquid, gel, particulate suspension, powder, etc.) of the desirable agents. In addition to multiple variations of agent delivery systems that can be incorporated in the spill-resistant cup 100, the characteristics of the spill-resistant cup 100 can also have variations in design. For example, FIG. 15 is a side view illustrating a spill-resistant cup 1500 in accordance with another embodiment of the present disclosure. The cup 1500 includes a handle 1502 for grasping the cup 1500. In the illustrated embodiment, the handle 1502 is integrally formed with the lid assembly 1504; however, in other embodiments, the handle 1502 can include additional handles and or be integrally formed with the cup body 1506. The cup 1500 is also molded to have a slender central section 1508 which can be easier for a hand to grasp, specifically a child's hand.

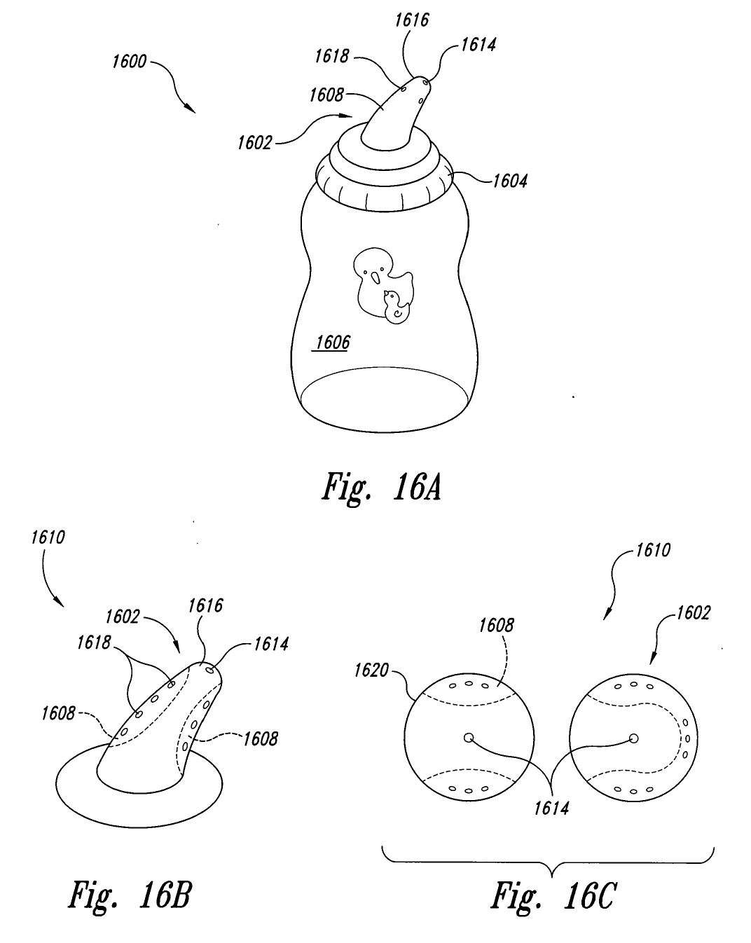

FIG. 16A is an isometric view illustrating a spill-resistant bottle 1600 having a drinking spout 1602 in accordance with an embodiment of present disclosure. The drinking spout 1602 can be pliable (e.g., a bottle nipple) and made from a material such as rubber. Additionally, the drinking spout 1602 can be removeably attached to a lid assembly 1604 such that the drinking spout 1602 can be cleaned and/or sterilized separately from the lid assembly 1604 and a cup body 1606.

In one embodiment, the pliable drinking spout 1602 illustrated in FIG. 16A includes one or more integrated agent dispensers 1608. FIG. 16B is an exploded partially schematic isometric view of the drinking spout 1602 of FIG. 16A illustrating an agent delivery system 1610 and FIG. 16C is a partially schematic top view illustrating the drinking spout 1602 of FIG. 16B having one or two integrated agent dispensers 1608 in accordance with embodiment of present disclosure. Referring to FIGS. 16A-C together, the drinking spout 1602 can include a primary drinking hole 1614 at a spout terminal end 1616 for delivery of a primary beverage to an infant/child's mouth upon sucking action. The drinking spout 1602 can also include one or more secondary holes 1618 aligned with the integrated agent dispensers 1608 and can be positioned around an outer circumference 1620 of the drinking spout 1602.

In one embodiment, the agent can be accessed by the infant/child by chewing on the pliable chewing spout 1602. For example, the chewing action can temporarily deform the spout 1602 such that agent can be released through the secondary holes 1618. The volume of agent present in the integrated agent dispensers 1608 can be sufficient for one or multiple uses. In some embodiments, the drinking spout 1602 can be discarded after the agent has been fully dispersed from the integrated agent dispenser(s) 1608. In other embodiments, the integral agent dispenser(s) 1608 can be refilled with additional agent such that the drinking spout can be reused.

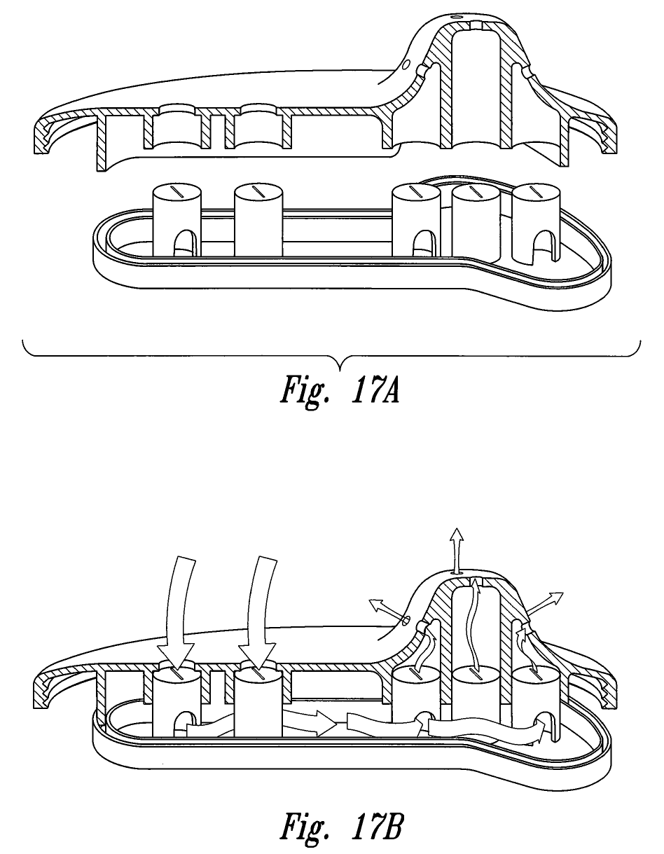

FIGS. 17A and 17B are partially cut-away, top isometric views of a lid assembly in accordance with another embodiment of the present disclosure. The lid assembly has an upper lid portion that receives a valve base with one or more valves. The upper lid and the valve base are configured to provide a chamber therebetween configured to receive and contain a dose of the selected agent. In the illustrated embodiment, the valve base has an agent input valve in fluid communication with the chamber. The agent input valve is configured to receive one or more doses of the agent therethrough into the chamber. The valve base also has one or more agent output valves adjacent to a drinking spout in the lid portion and in fluid communication with one or more apertures in the drinking spout for delivery of the agent into the user's mouth.

The illustrated valve base also includes an air input valve configured to allow air to flow into the cup (not shown) to facilitate flow of the primary beverage while the user is drinking through the spout. The valve base also has a beverage outlet valve in communication with the drinking spout to direct the flow of the primary beverage from the cup, through the lid assembly and into the user's mouth. In the illustrated embodiment, the lid portion and the valve base are configured so the primary beverage and the agent remain isolated from each other until they exit the drinking spout. In another embodiment, the lid assembly can be configured with a mixing chamber that allows the primary beverage and the agent to be combined before delivery into the user's mouth.

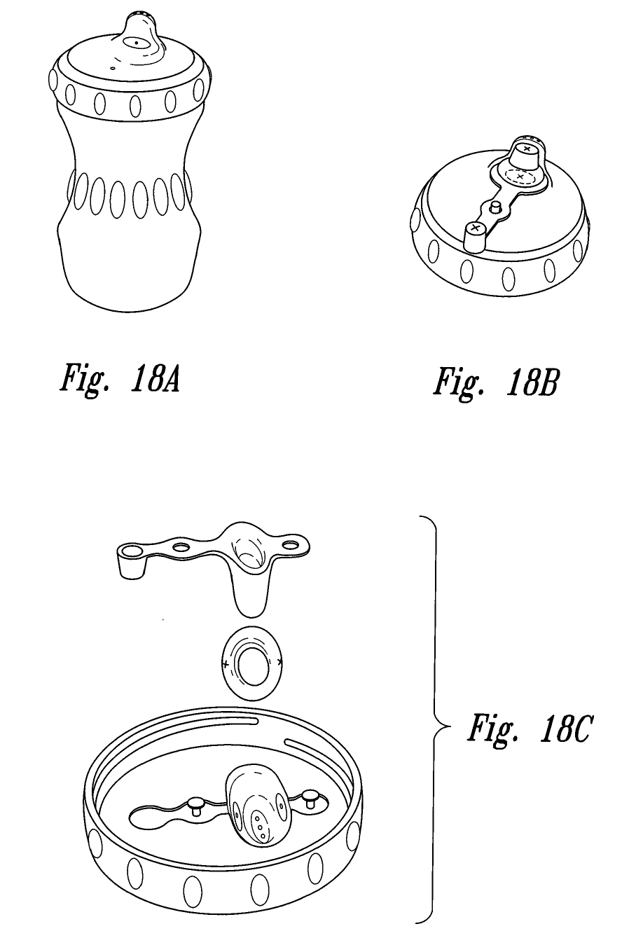

FIGS. 18A-C are schematic isometric views of a lid assembly in accordance with another embodiment of the present disclosure. In the illustrated embodiment, the lid assembly connects to a cup or other receptacle (FIG. 18A). The lid assembly has a drinking spout with one or more apertures for dispensing the agent, and one or more apertures for dispensing the primary beverage. The illustrated drinking spout has a compressible area, such as a soft chew area, that can be compressed during a drinking action to open the agent apertures and allow the agent to be dispensed into the user's mouth. As seen in FIGS. 18B and 18C, the lid assembly includes a lid portion (e.g., an elastomer-overmolded lid) that removeably receives a valve module. The valve module has an air inlet valve in communication with the cup, and a beverage outlet valve that extends into the drinking spout. The beverage outlet valve is in fluid communication with the internal area of the cup so the primary beverage can flow through the outlet valve and through the drinking spout when the user is drinking.

In the illustrated embodiment, and agent carrier is configured to fit within the drinking spout adjacent to the agent apertures and adjacent to the beverage outlet valve. The agent carrier is configured to deliver the agent into the user's mouth through the agent apertures when opened by the user (i.e., by compressing or sucking on the compressible area, discussed above) during a normal drinking action by the user. Accordingly, the agent and the primary beverage can be isolated from each other until they enter the user's mouth. In another embodiment, the lid assembly can be provided with a mixing chamber that allows a portion of the agent and the primary beverage to mix before delivery through the drinking spout to the user.

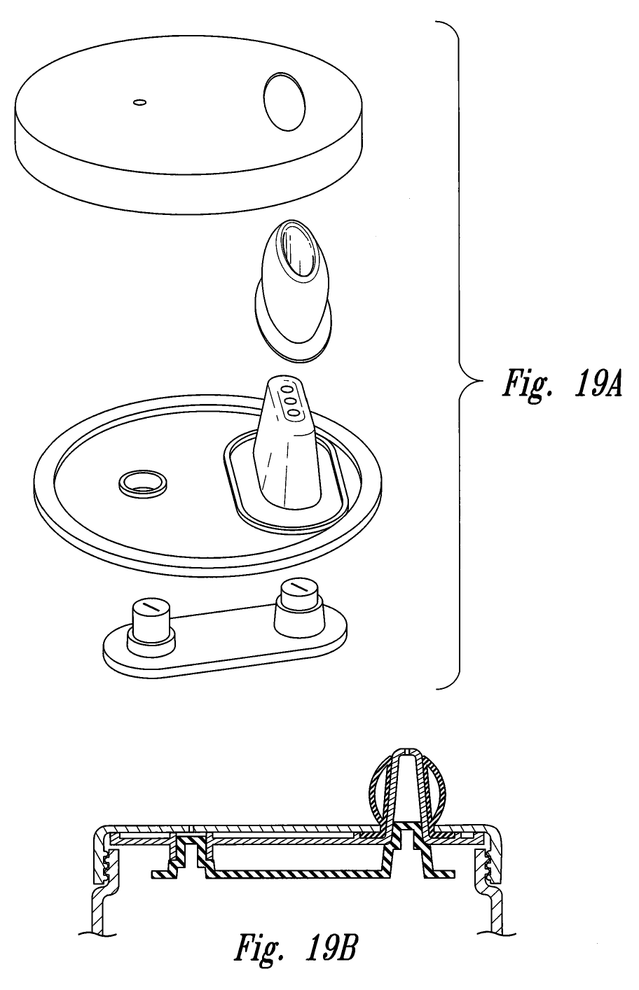

FIG. 19A is a schematic, exploded isometric view and FIG. 19B is a cross-sectional view of a lid assembly in accordance with another embodiment of the present disclosure. In the illustrated embodiment, the lid assembly has a lid portion with a spout aperture therein, and a mouthpiece/seal assembly that fits within the lid portion and that has a drinking spout that projects through the lid's spout aperture. The lid portion and the mouthpiece/seal are constructed to receive a removable and replaceable agent carrier, such as a capsule, that contains a selected dosage of the agent. The agent carrier of the illustrated embodiment is positioned to extend around at least a portion of the drinking spout so the user's mouth (lips, tongue, gums, and/or teeth) will engage, compress, and/or suck upon the agent carrier during the drinking process. The agent carrier can be a flexible member having an outlet valve configured to deliver the agent contained therein to the user's mouth during the drinking process. The outlet valve is a one-way valve so that the agent can be forced or drawn out, but other material (i.e., saliva, primary beverage, or other material), will not enter the agent carrier.

The agent carrier of the illustrated embodiment is an annular member configured so the drinking spout extends through an aperture in the carrier. Accordingly, the primary beverage will be isolated from the agent until they enter the user's mouth during the drinking process. The lid assembly of the illustrated embodiment is also configured to removeably receive a valve device below the mouthpiece/seal that prevents the primary beverage from spilling out of the spout when the user is not drinking. The valve device also includes and air inlet valve that allows air to flow into the cup or other container during the drinking process to provide a desired flow of the primary beverage to the user. When the user is drinking the primary beverage, and after the agent has been delivered to the user, the primary beverage will continue to flow to the user, and the agent carrier can act as a flexible shield to protect the drinking spout from excessive wear and tear, such as when may occur if, as an example, the user uses a chewing action while drinking.

An advantage of the spill-resistant cups disclosed herein is that the cups are provided with agent delivery systems for effectively delivering active ingredients that protect and/or rebuild teeth enamel. In addition to reducing the risk of problems associated with drinking sugary and/or acidic beverages, the agent delivery systems disclosed herein are also suitable to deliver active agents that can help reverse early caries (e.g., CPP-APP, fluoride, etc.) which can provide teeth enamel with more resistance to subsequent acid challenges.

Additionally, the agent delivery systems can dispense active ingredients/agents simultaneously as sugary and/or acidic beverages are consumed so that the teeth can be bathed when acid challenges and/or enamel erosion are likely to occur. Furthermore, the systems disclosed herein can accommodate agents that can be mixed with the primary beverage prior to delivery as well as those that can be delivered separately.

From the foregoing, it will be appreciated that specific embodiments of the disclosure have been described herein for purposes of illustration, but that various modifications may be made without deviating from the disclosure. Furthermore, aspects of the disclosure described in the context of particular embodiments may be combined or eliminated in other embodiments. Further, while features and characteristics associated with certain embodiments of the disclosure have been described in the context of those embodiments, other embodiments may also exhibit such features and characteristics, and not all embodiments need necessarily exhibit such features and characteristics to fall within the scope of the disclosure. Accordingly, the disclosure is not limited, except as by the appended claims.

I/We claim:

1. A spill-resistant cup for administering an active ingredient to a user for teeth protection, comprising:
a cup body defining a chamber configured to contain a beverage;
a lid assembly including a drinking spout having one or more drinking holes, the drinking spout configured to be engaged by the user's mouth, wherein the lid assembly engages the cup body to enclose the chamber;
an agent delivery system couplable to the lid assembly and in fluid communication with the chamber, the agent delivery system configured for controlled delivery of the active ingredient substantially simultaneously with delivery of an initial portion of the beverage, wherein the agent delivery system has an agent retaining portion that retains the active ingredient in a position separate from the beverage and in a position for delivery with the initial portion of the beverage; and
a flow control element coupled to the lid assembly and configured to block the beverage from spilling out of the chamber.

2. The spill-resistant cup of claim 1 wherein the agent retaining portion is in fluid communication with the drinking spout and is configured to dispense the active ingredient through the drinking spout.

3. The spill-resistant cup of claim 1 wherein the lid assembly has a mixing chamber in fluid communication with the drinking spout and the chamber, the mixing chamber being configured to allow the active ingredient to mix with an initial portion of the beverage prior to delivery through the drinking spout.

4. The spill-resistant cup of claim 1 wherein the drinking spout includes the one or more spaced-apart drinking holes adjacent to a terminal end of the spout and one or more spaced-apart agent delivery holes on a palette side of the drinking spout.

5. The spill-resistant cup of claim 4 wherein the agent retaining portion is in fluid communication with the agent delivery holds and is configured for storing and dispensing the active ingredient to the user through the drinking spout.

6. The spill-resistant cup of claim 4 wherein individual agent delivery holes include a flow control element for controlling delivery of the active ingredient through the drinking spout.

7. The spill-resistant cup of claim 1 wherein the agent retaining portion is configured to isolate the active ingredient in a liquid, power, solid, or gel form.

8. The spill-resistant cup of claim 1, further comprising an agent cartridge having a carrier that carries the active ingredient and wherein the agent cartridge is connectable to the agent retaining portion.

9. The spill-resistant cup of claim 8 wherein the carrier of the agent cartridge is substantially consumable upon contact with the beverage.

10. The spill-resistant cup of claim 8 wherein the carrier of the agent cartridge is non-consumable upon contact with the beverage and is disposable.

11. The spill-resistant cup of claim 1 wherein flow control element is configured to limit a flow rate of the beverage from the chamber to the drinking holes in the drinking spout.

12. The spill-resistant cup of claim 1 wherein the flow control element includes a membrane having one or more spaced apart apertures, the apertures being in a closed configuration in a resting state and in an open position when a user applies a pressure differential through the drinking spout.

13. The spill-resistant cup of claim 1 wherein the flow control element includes a one-way valve intermediate the chamber and the agent retaining portion.

14. The spill-resistant cup of claim 1 wherein the agent retaining portion is configured to contain only a single dose of the active ingredient at a time.

15. The spill-resistant cup of claim 18 wherein the agent retaining portion is configured to contain a plurality of independent doses of the active ingredient.

16. The spill-resistant cup of claim 1, further comprising an agent carrier that includes a dose of a dissolvable formulation of the active ingredient, wherein the agent carrier is connectable to the lid assembly for delivery to the user with the beverage.

17. A spill-resistant cup, comprising:
a cup body defining a beverage holding chamber;
a lid assembly releaseably attached to the cup body for opening and closing the beverage holding chamber;
a spout coupled to the lid assembly, the spout having one or more drinking holes;
a flow control element for separating the beverage holding chamber from at least a portion of the spout for controlling flow of a beverage from the beverage holding chamber into the spout;
an agent delivery system having an agent dispenser for dispensing an agent in a rate-controlled manner into the spout for delivery with an initial portion of the beverage to a user's mouth, wherein the agent includes an active ingredient for protecting tooth enamel from demineralization.

18. The spill-resistant cup of claim 17 wherein the agent delivery system includes a mixing chamber in a portion of the spout, and wherein the agent dispenser is positioned to dispense the agent into the mixing chamber and the flow control element controls flow of the beverage from the beverage holding chamber into the mixing chamber.

19. The spill-resistant cup of claim 17 wherein:
the agent delivery system includes an agent conduit and one or more agent delivery holes disposed in the spout;
the agent dispenser dispenses agent into the agent conduit and through the agent delivery holes; and
the agent is isolated from the beverage prior to deliver to a consumer's mouth.

20. The spill-resistant cup of claim 17 wherein at least one of the lid portion and the spout have a mixing chamber configured to allow the active ingredient to mix with an initial portion of the beverage prior to delivery through the drinking spout.

21. The spill-resistant cup of claim 17 wherein the agent delivery system is configured to isolate the active ingredient in a liquid, power, solid, or gel form.

22. The spill-resistant cup of claim 17, further comprising an agent cartridge having a carrier that carries the active ingredient and wherein the agent cartridge is connectable to the agent delivery system.

23. The spill-resistant cup of claim 17 wherein the agent delivery system is configured to contain only a single dose of the active ingredient at a time.

24. The spill-resistant cup of claim 17 wherein the agent delivery system is configured to contain a plurality of independent doses of the active ingredient.

25. A spill-resistant cup for administering an active ingredient for teeth protection comprising:
a cup body defining a beverage holding chamber;
a lid portion releaseably attached to the cup body for opening and closing the beverage holding chamber;
a spout coupled to the lid portion, the spout having one or more drinking holes in fluid communication with the beverage holding chamber;
a flow control element for separating the beverage holding chamber from at least a portion of the spout for controlling flow of a beverage from the beverage holding chamber into the spout;
a dissolvable formulation of the active ingredient positioned between the flow control element and the drinking holes, the formulation configured to dissolve at a dissolution rate when contacted by the beverage flowing through the flow control element.

26. An assembly for a spill-resistant cup having a chamber configured to contain a beverage, the lid assembly being usable for administering an active ingredient to a user for teeth protection, comprising:
a lid portion including a drinking spout having one or more drinking holes, the drinking spout configured to be engaged by the user's mouth;
an agent delivery system couplable to the lid portion and in fluid communication with the chamber, the agent delivery system configured for controlled delivery of the active ingredient to the user's mouth substantially simultaneously with delivery of an initial portion of the beverage, wherein the agent delivery system has an agent retaining portion that retains the active ingredient in a position separate from the beverage and in a position for delivery to the user's mouth with the initial portion of the beverage; and
a flow control element coupled to the lid assembly and configured to block the beverage from spilling out of the chamber.

27. The assembly of claim 26 wherein the agent retaining portion is in fluid communication with the drinking spout and is configured to dispense the active ingredient through the drinking spout.

28. The assembly of claim 26 wherein the lid portion has a mixing chamber in fluid communication with the drinking spout and the chamber, the mixing chamber being configured to allow the active ingredient to mix with an initial portion of the beverage prior to delivery through the drinking spout.

29. The assembly of claim 26 wherein the agent retaining portion is configured to isolate the active ingredient in a liquid, power, solid, or gel form.

30. The assembly of claim 26, further comprising an agent cartridge having a carrier that carries the active ingredient and wherein the agent cartridge is connectable to the agent retaining portion.

31. The assembly of claim 30 wherein the carrier of the agent cartridge is substantially consumable upon contact with the beverage.

32. The assembly of claim 26 wherein the agent retaining portion is configured to contain only a single dose of the active ingredient at a time.

33. The assembly of claim 26 wherein the agent retaining portion is configured to contain a plurality of independent doses of the active ingredient.
